(19) United States
(12) Patent Application Publication
(10) Pub. No.: US 2024/0253571 A1
(43) Pub. Date: Aug. 1, 2024

(54) Vehicle Caddy Device

(71) Applicant: Lillian Steyne, Pensacola, FL (US)

(72) Inventor: Lillian Steyne, Pensacola, FL (US)

(21) Appl. No.: 18/326,131

(22) Filed: May 31, 2023

Related U.S. Application Data
(60) Provisional application No. 63/441,863, filed on Jan. 30, 2023.

(51) Int. Cl. B60R 7/04

(52) U.S. Cl. CPC B60R 7/04

(57) ABSTRACT

A vehicle storage caddy device is provided. The device can be used in a handicap-accessible vehicle in between the front seats, such that the device acts like a center console and can be used for storage. In addition, the device prevents objects from rolling under the front seats due to the positioning of the device between said seats. The device may have a plurality of internal and external storage areas, openings, and fasteners for storing various items.

### CROSS-REFERENCE TO RELATED APPLICATION

The present application claims priority to, and the benefit of, U.S. Provisional Application No. 63/441,863, which was filed on Jan. 30, 2023, and is incorporated herein by reference in its entirety.

### FIELD OF THE INVENTION

The present invention relates generally to the field of vehicle interior storage devices. More specifically, the present invention relates to a vehicle caddy device that can be used as a central console and storage area in a handicapped transportation vehicle that lacks a center console. The device also prevents items from rolling under the front seats of said transportation vehicle. Accordingly, the present disclosure makes specific reference thereto. Nonetheless, it is to be appreciated that aspects of the present invention are also equally applicable to other like applications, devices, and methods of manufacture.

### BACKGROUND

Within a handicapped transportation vehicle, a large amount of space is typically present between the driver and passenger due to the design of the vehicle. This can ultimately lead to dropped items rolling underneath seats and being difficult to locate. As a result, a user must park the vehicle to locate the item, which can be frustrating. In addition, individuals may lack the storage features found in a traditional vehicle center console, which may be absent in handicapped transportation vehicles.

Therefore, there exists a long-felt need in the art for a storage device for a handicapped transportation vehicle. More specifically, there exists a long-felt need in the art for a vehicle caddy device that can be placed within the opening between the driver's seat and passenger's seat of a handicapped transportation vehicle. There also exists a long-felt need in the art for a vehicle caddy device that can be placed within the opening between the driver's seat and passenger's seat of a handicapped transportation vehicle, wherein the device allows a user to store a plurality of items. Furthermore, there exists a long-felt need in the art for a vehicle caddy device that can be placed within the opening between the driver's seat and passenger's seat of a handicapped transportation vehicle, wherein the device prevents items from rolling under the driver's seat and passenger's seat.

The subject matter disclosed and claimed herein, in one embodiment thereof, comprises a vehicle caddy device. The device is intended to be in a handicap-accessible vehicle in between the front seats, such that the device acts like a center console and can be used for storage. In addition, the device prevents objects from rolling under the front seats due to the positioning of the device between said seats. The device may have a plurality of internal and external storage areas, openings, and fasteners for storing various items. In one embodiment, the bottom wall of the device may be fastened to the floor of the vehicle to secure the device during movement of the vehicle.

In this manner, the vehicle caddy device of the present invention accomplishes all the foregoing objectives and provides a storage device for a handicapped transportation vehicle that can be placed within the opening between the driver's seat and passenger's seat of a handicapped transportation vehicle. While doing so, the placement of the device stops items from rolling under the driver's seat and passenger's seat. The device also allows a user to store a plurality of items in a center console-like fashion.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle caddy device. The device is intended to be used inside the interior of a handicap-accessible vehicle in between the front seats to act as a center console-like structure. In addition, the device can be used in any vehicle without a center console or can be used in other areas of a vehicle. The body of the device is preferably generally rectangular or square in shape. A bottom wall may be comprised of at least one fastener that allows the device to be secured to a vehicle floor between the front seats of the vehicle.

Any portion of the body may be comprised of at least one recessed area that may allow a user to store a plurality of items within the area without losing said items. The top wall (or any other area of the body) may be comprised of at least one opening that may be configured to receive a beverage, a cellphone, a tablet, loose change, or any other item. As a result, said items can be stored in an easily accessible manner. In addition, the top wall (or any other area of the body) may be comprised of at least one internal storage area that can be accessed via a lid that rotates about at least one hinge. Similarly, the back wall (or any other area of the body) may be comprised of at least one internal storage area. The storage area can be accessed via a door that rotates about at least one hinge. The back wall may also be comprised of at least one fastener to store various items.

The present invention may also be comprised of a method of using the device. First, a device is provided comprised of a body which is comprised of a bottom wall comprised of a fastener, at least one internal storage area, and at least one recessed area. Then, the device can be placed (and in one embodiment, fastened) on a vehicle floor of a handicapped transportation vehicle between the two front seats. A user can then use the device to store at least one item.

Accordingly, the vehicle caddy device of the present invention is particularly advantageous as it provides a storage device for a handicapped transportation vehicle that can be placed within the opening between the driver's seat and passenger's seat of a handicapped transportation vehicle. While doing so, the placement of the device stops items from rolling under the driver's seat and passenger's seat. The device also allows a user to store a plurality of items in a center console-like fashion. In this manner, the vehicle caddy device provides a solution to problems faced within handicapped transportation vehicles.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates multiple perspective views of one potential embodiment of a vehicle caddy device of the present invention in accordance with the disclosed architecture;

FIG. 2 illustrates a rear view of one potential embodiment of a vehicle caddy device of the present invention while positioned within a vehicle in accordance with the disclosed architecture;

FIG. 3 illustrates a top perspective view of one potential embodiment of a vehicle caddy device of the present invention in accordance with the disclosed architecture;

FIG. 4 illustrates a rear perspective view of one potential embodiment of a vehicle caddy device of the present invention in accordance with the disclosed architecture; and

FIG. 5 illustrates a flowchart of a method of using one potential embodiment of a vehicle caddy device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a storage device for a handicapped transportation vehicle. More specifically, there exists a long-felt need in the art for a vehicle caddy device that can be placed within the opening between the driver's seat and passenger's seat of a handicapped transportation vehicle. There also exists a long-felt need in the art for a vehicle caddy device that can be placed within the opening between the driver's seat and passenger's seat of a handicapped transportation vehicle, wherein the device allows a user to store a plurality of items. Furthermore, there exists a long-felt need in the art for a vehicle caddy device that can be placed within the opening between the driver's seat and passenger's seat of a handicapped transportation vehicle, wherein the device prevents items from rolling under the driver's seat and passenger's seat.

The present invention, in one exemplary embodiment, is comprised of a vehicle caddy device. The device is intended to be used inside the interior of a handicap-accessible vehicle in between the front seats to act as a center console-like structure. The body of the device is preferably generally rectangular or square in shape. A bottom wall may be comprised of at least one fastener that allows the device to be secured to a vehicle floor between the front seats of the vehicle.

Any portion of the body may be comprised of at least one recessed area. The area may allow a user to store a plurality of items within the area without losing said items. The top wall (or any other area of the body) may be comprised of at least one opening that may be configured to receive a beverage, cellphone, tablet, loose change, or any other item. As a result, said items can be stored in an easily accessible manner. In addition, the top wall (or any other area of the body) may be comprised of at least one internal storage area that can be accessed via a lid that rotates about at least one hinge. Similarly, the back wall (or any other area of the body) may be comprised of at least one internal storage area. The storage area can be accessed via a door that rotates about at least one hinge. The back wall may also be comprised of at least one fastener to store various items.

The present invention may also be comprised of a method of using the device. First, a device is provided comprised of a body which is comprised of a bottom wall comprised of a fastener, at least one internal storage area, and at least one recessed area. Then, the device can be placed (and in one embodiment, fastened) on a vehicle floor of a handicap transportation vehicle between the two front seats. A user can then use the device to store at least one item.

Accordingly, the vehicle caddy device of the present invention is particularly advantageous as it provides a storage device for a handicapped transportation vehicle that can be placed within the opening between the driver's seat and passenger's seat of a handicapped transportation vehicle. While doing so, the placement of the device stops items from rolling under the driver's seat and passenger's seat. The device also allows a user to store a plurality of items in a center console-like fashion. In this manner, the vehicle caddy device provides a solution to problems faced within handicapped transportation vehicles.

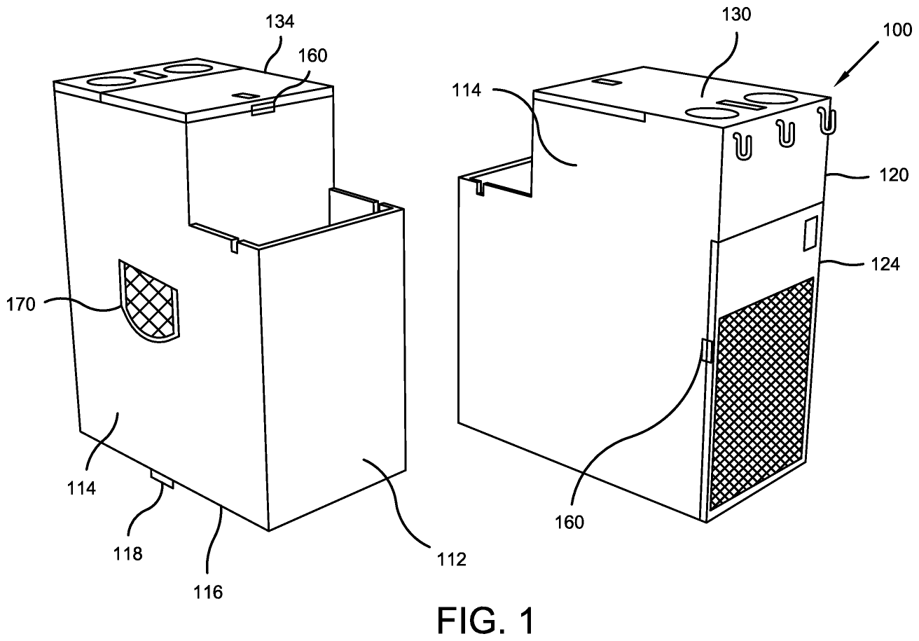

Referring initially to the drawings, FIG. 1 illustrates multiple perspective views of one potential embodiment of a vehicle caddy device 100 of the present invention in accordance with the disclosed architecture. The device 100 is intended to be used inside the interior of a vehicle. More specifically, the device 100 is intended to be used in a handicap-accessible vehicle in between the front seats 12. In this manner, the device 100 acts as a center console-like structure. In addition, the device 100 can be used in any vehicle without a center console or can be used in other areas of a vehicle.

The body 110 of the device 100 is preferably generally rectangular or square in shape. In said embodiment, the body 110 is comprised of a front wall 112 and a parallel back wall 120, a pair of parallel side walls 114, and a bottom wall 116 parallel with a top wall 130. The device 100 is preferably made from a rigid plastic material or a lightweight metal material such as, but not limited to, aluminum.

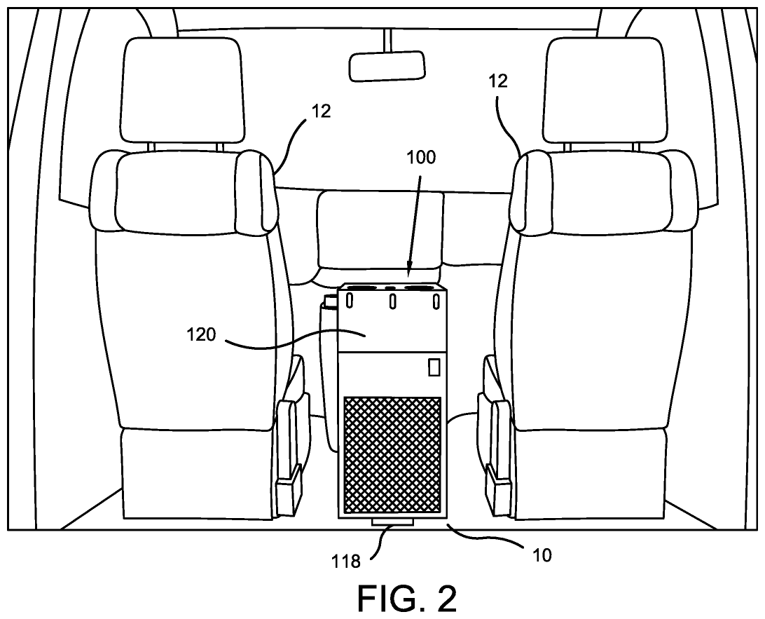

The bottom wall 116 may be comprised of at least one fastener 118. The fastener 118 allows the device 100 to be secured to a vehicle floor 10 between the front seats 12 of the vehicle, as seen in FIG. 2. The fastener 118 may be any fastener known in the art such as, but not limited to, clip, clamp, magnet, hook, loop, etc. Alternatively, the bottom wall 116 may have increased weight to prevent the device 100 from moving. In other embodiments, the fastener 118 may be found on the side walls 114 of the body 110 to allow the device 100 to attach to various structures and in a plurality of ways within a vehicle. The bottom wall 116 may also be comprised of a non-slip material, such as, but not limited to, rubber, which prevents the bottom wall 116 from sliding on the vehicle floor 10. The non-slip material may be textured via a raised or recessed texture to increase grip.

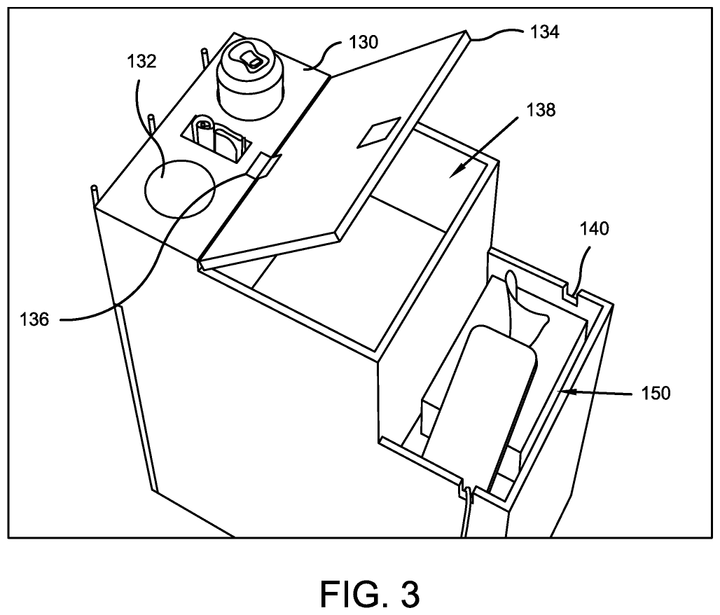

Any portion of the body 110 may be comprised of at least one recessed area 150, as seen in FIG. 3. The recessed area 150 may allow a user to store a plurality of items within the area 150 without losing said items. For example, in one embodiment, the area 150 may be designed to accommodate a cell phone, wherein the area 150 is comprised of at least one cutout 140 to allow a charging cord to enter the area 150. The area 150 is preferably recessed enough such that items cannot easily fall out of the area 150 while the vehicle is in motion.

The top wall 130 (or any other area of the body 110) may be comprised of at least one opening 132. The opening 132 may be configured to receive a beverage, cellphone, tablet, loose change, or any other item. As a result, said items can be stored in an easily accessible manner.

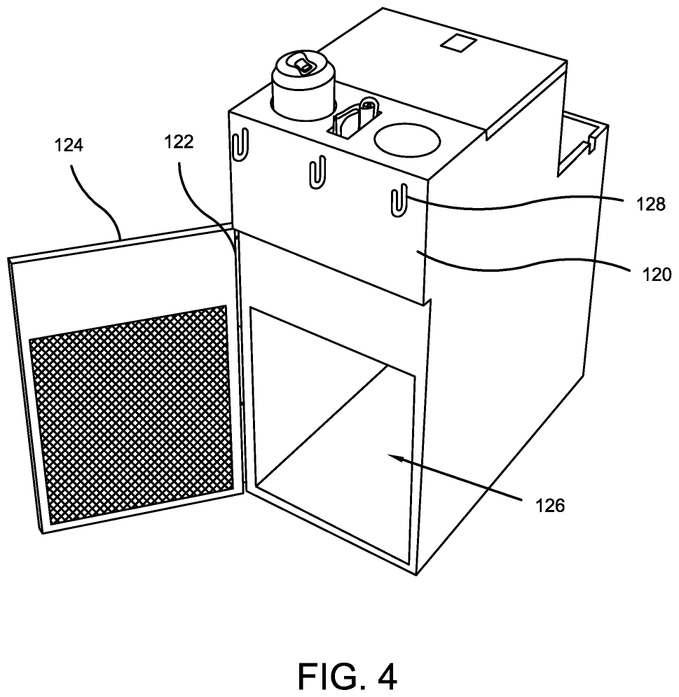

The top wall 130 (or any other area of the body 110) may be comprised of at least one internal storage area 138, as seen in FIG. 4. The area 138 may be sized and configured to receive any item or collection of items. The storage area 138 can be accessed via a lid 134 that rotates about at least one hinge 136. The lid 134 may be secured to the top wall 130 via at least one locking mechanism 160. The locking mechanism 160 may be any lock or locking mechanism known in the art.

The back wall 120 (or any other area of the body 110) may be comprised of at least one internal storage area 126. The area 126 may be sized and configured to receive any item or collection of items. The storage area 126 can be accessed via a door 124 that rotates about at least one hinge 122. The door 124 may be secured to the back wall 120 via at least one locking mechanism 160. The locking mechanism 160 may be any lock or locking mechanism known in the art.

The back wall 120 (or any other area of the body 110) may also be comprised of at least one fastener 128. The fastener 128 may be any type known in the art such as, but not limited to, a hook, a clip, a hook fastener, a loop fastener, a magnet, a cellphone/smart device holder, etc., to store various items.

Any exterior surface of the body 110 may be comprised of at least one cargo storage net 170. The cargo net 170 allows a user to store an item within the net 170 such that it can be easily accessed.

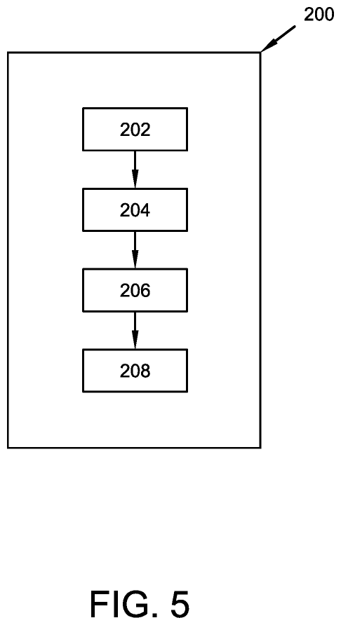

The present invention may also be comprised of a method of using 200 the device 100, as seen in FIG. 5. First, a device 100 is provided comprised of a body 110 which is comprised of at least one internal storage area 138, at least one recessed area 150, and a bottom wall 116 comprised of at least one fastener 118 [Step 202]. Then, the device 100 can be placed on a vehicle floor 10 of a handicap transportation vehicle between the two front seats 12 [Step 204]. If the device 100 is an embodiment in which at least one fastener 118 is on the bottom wall 116, the fastener 118 can be used to secure the device 100 to the floor 10 [Step 206]. A user can then use the device 100 to store at least one item [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle caddy device” and “device” are interchangeable and refer to the vehicle caddy device 100 of the present invention.

Notwithstanding the foregoing, the vehicle caddy device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle caddy device 100 as shown in the FIGS. are for illustrative purposes only, and that many other sizes and shapes of the vehicle caddy device 100 are well within the scope of the present disclosure. Although the dimensions of the vehicle caddy device 100 are important design parameters for user convenience, the vehicle caddy device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle caddy device comprising:
a body comprised of a bottom wall;
a recessed area positioned on the body;
an internal storage area positioned on the body; and
an opening positioned on the body.

2. The vehicle caddy device of claim 1 further comprised of a cargo storage net positioned on the body.

3. The vehicle caddy device of claim 2, wherein the cargo storage net is positioned on a side wall of the body.

4. The vehicle caddy device of claim 1, wherein the bottom wall is comprised of a weighted bottom wall.

5. The vehicle caddy device of claim 1, wherein the recessed area is comprised of a cutout.

6. The vehicle caddy device of claim 1, wherein the internal storage area is covered by a lid.

7. The vehicle caddy device of claim 5, wherein the lid attaches to the body via a hinge.

8. The vehicle caddy device of claim 6, wherein the lid is comprised of a locking mechanism.

9. A vehicle caddy device comprising:
a body comprised of a bottom wall;
a first fastener;
a recessed area;
an internal storage area comprised of a lid;
an opening; and
a second fastener positioned on the body.

10. The vehicle caddy device of claim 9, wherein the second fastener is comprised of a hook.

11. The vehicle caddy device of claim 9 further comprised of a cargo storage net.

12. The vehicle caddy device of claim 9, wherein the first fastener is comprised of a clip, a clamp, a magnet, a hook fastener, or a loop fastener.

13. The vehicle caddy device of claim 12, wherein the first fastener is positioned on the bottom wall.

14. The vehicle caddy device of claim 12, wherein the first fastener is positioned on a side wall of the body.

15. The vehicle caddy device of claim 9, wherein the lid is comprised of a locking mechanism.

16. The vehicle caddy device of claim 9, wherein the second fastener is comprised of a clip, a hook fastener, a loop fastener, a magnet, or a cellphone holder.

17. The vehicle caddy device of claim 9, wherein the bottom wall is comprised of a non-slip material.

18. The vehicle caddy device of claim 17, wherein the non-slip material is comprised of a rubber material.

19. The vehicle caddy device of claim 18, wherein the rubber material is comprised of a textured rubber.

20. A method of using a vehicle caddy device, the method comprising the following steps:
providing a vehicle caddy device comprised of a body comprised of an internal storage area, a recessed area, and a bottom wall;
placing the vehicle caddy device on a vehicle floor of a handicap transportation vehicle between a first front seat and a second front seat; and
using the vehicle caddy device to store an item.
